(19) United States
(12) Patent Application Publication
(10) Pub. No.: US 2016/0063498 A1
(43) Pub. Date: Mar. 3, 2016

(54) Payment Implementation Method, Relevant Apparatus, and System

(71) Applicant: Tencent Technology (Shenzhen) Company Limited, Shenzhen (CN)

(72) Inventor: Jianli LI, Shenzhen (CN)

(21) Appl. No.: 14/937,446

(22) Filed: Nov. 10, 2015

Related U.S. Application Data
(63) Continuation of application No. PCT/CN2014/079603, filed on Jun. 10, 2014.

(30) Foreign Application Priority Data
Nov. 19, 2013 (CN) 201310586678.8

(51) Int. Cl. G06Q 20/40; G06Q 20/32

(52) U.S. Cl. CPC G06Q 20/405; G06Q 20/3221; G06Q 20/3226

(57) ABSTRACT

A computer server receives a payment request including a payment order sent by a first mobile client device. In response, the computer server allocates a first payment identifier to the payment order and returns a response including the first payment identifier to the first mobile client device. The first mobile client device generates an audio signal associated with the response and broadcasts the audio signal including the first payment identifier. The computer server receives a collection request including a second payment identifier and payee information from a second mobile client device. The collection request was generated by the second device in response to a detection of the audio signal broadcasted by the first mobile client device. If the second payment identifier corresponds to the first payment identifier, the computer server then processes the payment order using the payee information and sends a payment completion message to the first device.

### RELATED APPLICATIONS

This application is a continuation application of PCT Patent Application No. PCT/CN2014/079603, entitled “PAYMENT IMPLEMENTATION METHOD, RELEVANT APPARATUS, AND SYSTEM” filed on Jun. 10, 2014, which claims priority to Chinese Patent Application No. 201310586678.8, entitled “PAYMENT IMPLEMENTATION METHOD, RELEVANT APPARATUS, AND SYSTEM,” filed on Nov. 19, 2013, both of which are incorporated by reference in their entirety.

### TECHNICAL FIELD

The present application relates to the technical field of computer payment, and more particularly, to a payment implementation method, relevant apparatus, and system.

### BACKGROUND

In the modern economic society, payment is one of the essential economic activities for every person. With the ongoing development of technologies nowadays, a variety of payment manners have emerged, the most common ones being online payment and cash payment. Through online payment, people can transfer a sum of money between a payer and a payee over the Internet without leaving the house, and the payment manner is relatively convenient.

In existing online payment, after determining a payee user, a payer pays a sum of money to the payee in a network transfer manner. The implementation step is relatively troublesome; especially when a single user needs to initiate payment to a plurality of users, a sender user confirms account number information such as payee account numbers or other network wallets of payees one by one, and initiates a transfer process on the basis of every payee, resulting in that a long time is consumed for a payer, and errors occur easily, which causes damages to a user.

### SUMMARY

The above deficiencies and other problems associated with the conventional approach of processing an online payment are reduced or eliminated by the present application disclosed below. In some embodiments, the present application is implemented in a computer server that has one or more processors, memory and one or more modules, programs or sets of instructions stored in the memory for performing multiple functions and communicating with a client device (e.g., smartphone) that has one or more processors, memory and one or more modules, programs or sets of instructions stored in the memory for performing multiple functions. Instructions for performing these functions may be included in a computer program product configured for execution by one or more processors.

One aspect of the present application involves a method for performing a payment transaction at a computer server having one or more processors and memory storing program modules to be executed by the one or more processors. The computer server receives a payment request including a payment order sent by a first client device. In response, the computer server allocates a first payment identifier to the payment order and returns a response including the first payment identifier to the first client device. The first client device broadcasts an audio signal associated with the response and the audio signal includes information of the first payment identifier. Subsequently, the computer server receives a collection request including a second payment identifier and payee information from a second client device. The collection request was generated by a second client device in response to a detection of the audio signal broadcasted by the first client device. If the second payment identifier corresponds to the first payment identifier, the computer server then processes the payment order using the payee information and sends a payment completion message to the first client device.

Another aspect of the present application involves a computer server including one or more processors, memory, one or more program modules stored in the memory and to be executed by the one or more processors. The program modules further include instructions for: receiving a payment request including a payment order sent by a first client device; allocating a first payment identifier to the payment order and returning a response including the first payment identifier to the first client device, wherein the first client device is configured to broadcast an audio signal associated with the response and including information of the first payment identifier; receiving a collection request including a second payment identifier and payee information from a second client device, wherein the second client device is configured to generate the collection request in response to a detection of the audio signal broadcasted by the first client device; in accordance with a determination that the second payment identifier corresponds to the first payment identifier, processing the payment order using the payee information and sending a payment completion message to the first client device.

Another aspect of the present application involves a non-transitory computer readable storage medium stores one or more program modules in connection with a computer server having one or more processors, the program modules including instructions for execution by one or more processors. The instructions, when executed by the one or more processors, cause the computer server to perform operations including receiving a payment request including a payment order sent by a first client device; allocating a first payment identifier to the payment order and returning a response including the first payment identifier to the first client device, wherein the first client device is configured to broadcast an audio signal associated with the response and including information of the first payment identifier; receiving a collection request including a second payment identifier and payee information from a second client device, wherein the second client device is configured to generate the collection request in response to a detection of the audio signal broadcasted by the first client device; in accordance with a determination that the second payment identifier corresponds to the first payment identifier, processing the payment order using the payee information and sending a payment completion message to the first client device.

Various advantages of the present application are apparent in light of the descriptions below.

### BRIEF DESCRIPTION OF THE DRAWINGS

The aforementioned features and advantages of the present application as well as additional features and advantages thereof will be more clearly understood hereinafter as a result of a detailed description of preferred embodiments when taken in conjunction with the drawings.

To describe the technical solutions in the embodiments of the present application or in the prior art more clearly, the following briefly introduces the accompanying drawings required for describing the embodiments or the prior art. Apparently, the accompanying drawings in the following description show some embodiments of the present application, and persons of ordinary skill in the art may still derive other drawings from these accompanying drawings without creative efforts.

FIG. 1 is a schematic flow chart of a payment implementation method according to a first embodiment of the present application;

FIG. 2 is a schematic flow chart of a payment implementation method according to a second embodiment of the present application;

FIG. 3 is a schematic flow chart of a payment implementation method according to a third embodiment of the present application;

FIG. 4 is a schematic flow chart of a payment implementation method according to a fourth embodiment of the present application;

FIG. 5 is a schematic flow chart of a payment implementation method according to a fifth embodiment of the present application;

FIG. 6 is a schematic flow chart of a payment implementation method according to a sixth embodiment of the present application;

FIG. 7 is a schematic flow chart of a payment implementation method according to a seventh embodiment of the present application;

FIG. 8 is a schematic flow chart of a payment implementation method according to an eighth embodiment of the present application;

FIG. 9 is a schematic structural view of a payment implementation system according to an embodiment of the present application;

FIG. 10 is a schematic structural view of another payment implementation system according to an embodiment of the present application;

FIG. 11 is a schematic structural view of a payment implementation apparatus according to an embodiment of the present application;

FIG. 12 is a schematic structural view of a user terminal according to an embodiment of the present application;

FIG. 13 is a schematic structural view of a another payment implementation apparatus according to an embodiment of the present application;

FIG. 14 is a schematic structural view of a server according to an embodiment of the present application;

FIG. 15 is a schematic structural view of yet another payment implementation apparatus according to an embodiment of the present application; and

FIG. 16 is a schematic structural view of a user terminal according to an embodiment of the present application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

To make the objectives, technical solutions, and advantages of the present application more comprehensible, the present application is further illustrated in detail below with reference to the accompanying drawings and the embodiments. It should be understood that the described specific embodiments are only used to explain the present application rather than to limit the present application.

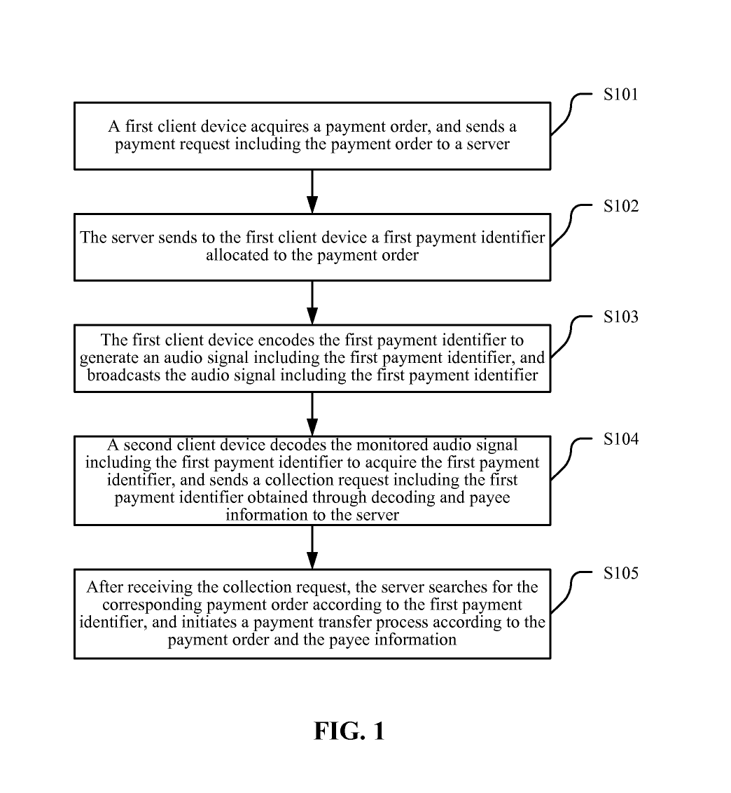

FIG. 1 is a schematic flow chart of a payment implementation method according to a first embodiment of the present application. The method in the embodiment of the present application may be implemented in a terminal used for payment and a corresponding payment server. Specifically, the method includes:

S101: A first client device acquires a payment order, and sends a payment request including the payment order to a server.

The first client device may be a mobile device, having a network function and set with a corresponding application, such as a smart mobile phone, a tablet computer, a personal computer, a wearable device, an electronic reader, a remote control, a vehicle-mounted device, of a payer.

The first client device acquires the payment order in several manners. Specifically, a payment interface is provided to prompt a user (e.g., the payer) to enter corresponding information. In the embodiment of the present application, a user may only enter payer information of the payer and sum information about an amount to pay. The payer information is used to enable the server to confirm account information and payment password information of the user and verify the identity of the user, whereas the sum information is used to notify the server an amount of a single sum to pay at the current time.

Of course, the payment order may also be acquired in other manners, for example, an existing payment order including the payer information and an amount/sum confirmed between a buyer and a seller.

The first client device generates, after acquiring the corresponding payment order, a payment request that is predefined with the server, so that the server executes relevant steps in the embodiment of the present application. The first client device may specifically send the generated payment request to the server over a communications network, e.g., the Internet.

S102: The server sends to the first client device a payment identifier allocated to the payment order.

After receiving the payment request, the server retrieves the payment order in the payment request according to a data format of the payment request predefined with the terminal, and then allocates a current unique payment identifier in the server, where the payment identifier is used to uniquely identify the payment order. In some embodiments, the payment order includes a payment account and a payment amount and the server generates the current unique payment identifier based on both the payment account and the payment amount information. In other words, the current unique payment identifier is at least in part dependent on the payment account and the payment amount. In some other embodiments, the current unique payment identifier is also dependent upon the current time of the computer server. By doing so, it is less likely for two payment orders to have the same payment identifier and makes the online payment process more secure.

The server may also send the payment identifier to the first client device over a communications network, e.g., the Internet. In some embodiments, before sending a response including the payment identifier, the computer server checks whether the payment account has sufficient fund for the payment amount. If not, the computer server generates a message indicating that the payment account has insufficient fund and returns the message to the first client device.

S103: The first client device encodes the payment identifier to generate an audio signal including the payment identifier, and broadcasts the audio signal including the payment identifier.

After receiving the payment identifier, the first client device encodes the payment identifier based on an audio coding rule set in an installed application to obtain an audio file carrying the payment identifier, that is, the audio signal including the payment identifier, and when necessary, the user chooses the audio file and plays the audio file with a terminal player. After the audio signal including the payment identifier is obtained through encoding, prompt information may be sent to prompt the user to play the audio signal including the payment identifier to one or more payee users to initiate payment.

S104: A second client device decodes the monitored audio signal including the payment identifier to acquire the payment identifier, and sends a collection request including the payment identifier obtained through decoding and payee information to the server.

The second client device may be, a mobile smart device, having a network function and set with a corresponding application, such as a smart mobile phone, a tablet computer, a personal computer, a wearable device, an electronic reader, a remote control, a vehicle-mounted device, of the payee user.

The second client device monitors and records the audio signal including the payment identifier played by the first client device with a built-in pickup device such as a microphone, and decodes the monitored audio signal including the payment identifier based on the corresponding audio coding rule to obtain the payment identifier in the audio signal including the payment identifier.

In some other embodiments, the computer server is responsible for generating the audio signal and encoding the payment identifier information into the audio signal. In this case, the first client device downloads the audio signal and stores the audio signal in a file locally at the first client device. For example, as described below, the payer and the payee may use the same client device to perform this payment transaction. In this case, the payer needs to log out of his/her account of the installed application so that the payee can log into his/her account of the same application to continue the transaction. In this case, the payee can play the audio file while turning on the audio signal detection module of the application to detect the audio signal. In other words, the device that broadcasts the audio signal and the device that detects the audio signal is the same client device. This may occur if the payer or the payee does not bring his/her client device but still wants to complete this payment transaction.

After obtaining the payment identifier, the second client device may also request to acquire the payee information, specifically, payee account number information of the payee user through a user interface, and generate a predefined collection request to send the collection request to the corresponding server, so that the server executes an existing process according to the embodiment of the present application. The second client device may specifically send the collection request to the server over a communications network, e.g., the Internet.

S105: After receiving the collection request, the server searches for the corresponding payment order according to the payment identifier, and initiates a payment transfer process according to the payment order and the payee information.

After receiving the collection request, the server may uniquely determine the payment order in S101 according to the payment identifier. After acquiring the payment order and the payee information, the server may initiate the payment transfer process according to the payer information and sum/amount in the payment order and the payee information. To put it simply, an account number corresponding to the payer information transfers, based on the sum/amount, a corresponding amount to a payee account number corresponding to the payee information. Specifically, the process of accomplishing payment based on the payment order and the payee information may be referred to the prior art, which is no longer elaborated here.

It should be noted that the first client device and the second client device can implement communications between the server and the client through an instant communication account number or a user identifier such as a payment account number of the user.

In addition, in the embodiment of the present application, the playing volume of the audio signal including the payment identifier may be further set to meet the requirement of playing at a short distance only. Further, a payment rule may be set the server end. For example, payment is executed only once for each piece of payee information, and the payee information is recorded to stop responding to a next collection request of the same payment identifier initiated according to the payee information.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user.

In some embodiments, the server generates one payment identifier for each payment order and returns the payment identifier to the first client device as described above. In this case, the first client device broadcasts an audio signal including the payment identifier. The second client device, upon detecting the audio signal, extracts the payment identifier from the detected audio signal and returns the payment identifier along with other information (e.g., the payee information) to the server. In this case, the server verifies the payment identifier returned by the second client device matches the payment identifier stored at the server and, if so, processes the payment order associated with the payment identifier.

In some other embodiments, the server generates two payment identifiers, a first payment identifier and a second payment identifier different from the first payment identifier, for each payment order and returns the first payment identifier to the first client device as described above. The first client device broadcasts an audio signal including the first payment identifier. The second client device, upon detecting the audio signal, extracts the first payment identifier from the detected audio signal and converts the first payment identifier into another payment identifier. The second client device then sends the converted payment identifier along with other information (e.g., the payee information) to the server. In this case, the server verifies whether the payment identifier returned by the second client device matches the second payment identifier stored at the server and, if so, processes the payment order associated with the second payment identifier.

In some embodiments, the server generates a timestamp for the payment request and the collection request, respectively, and then a time difference between the two requests using their respective timestamps. Before processing the corresponding payment order, the server compares the time difference with a predefined time threshold value (e.g., 60 seconds). If the time difference is less than or equal to the time threshold value, the server then processes the payment order (after the other security conditions are met as well). Otherwise, the server may generate a payment alert message and sends the payment alert message to the first client device. The payment alert message includes the payee information provided by the collection request. The server does not process the payment order until after the user of the first client device returns a payment confirmation message, e.g., within five minutes. By doing so, the server actually puts a time window for a payment request such that a collection request outside the time window has to be subject to additional security check before being processed.

Similarly, since most of the mobile devices have location-positioning modules (e.g., GPS), the payment request and the collection request may include the respective location information of the first and second client device. In this case, the server may generate a location difference between the payment request and the collection request and compares the location difference with a predefined location threshold value (e.g., five feet). If the location difference is less than or equal to the location threshold value, the server then processes the payment order (after the other security conditions are met as well). Otherwise, the server may generate a payment alert message and sends the payment alert message to the first client device. The payment alert message includes the payee information provided by the collection request. The server does not process the payment order until after the user of the first client device returns a payment confirmation message, e.g., within five minutes. By doing so, the server actually puts a location window for a payment request such that a collection request outside the location window has to be subject to additional security check before being processed. In some embodiments, the server may impose both a time window and a location window for a payment request (e.g., the payment amount exceeds a predefined threshold).

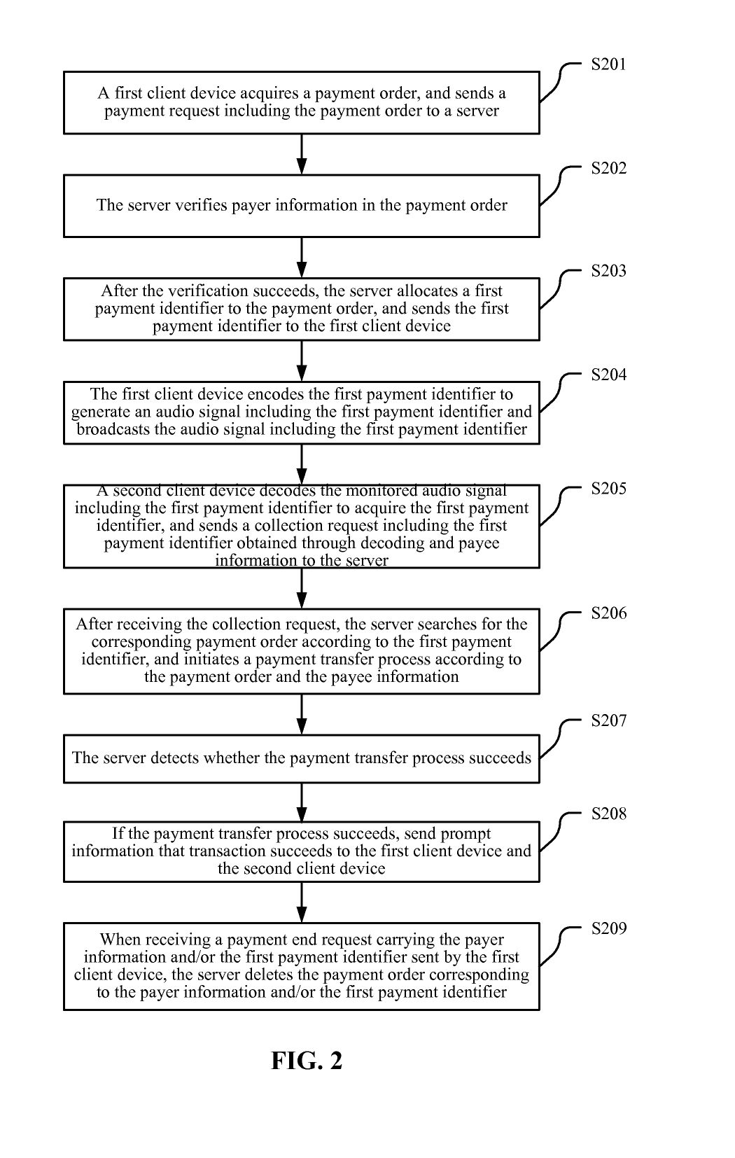

FIG. 2 is a schematic flow chart of a payment implementation method according to a second embodiment of the present application. The method according to an embodiment of the present application may be implemented in a terminal used for payment and a corresponding payment server. Specifically, the method includes:

S201: A first client device acquires a payment order, and sends a payment request including the payment order to a server, where the payment order includes payer information (e.g., a payment account) and sum information (e.g., a payment amount).

The first client device acquires the payment order in several manners. Specifically, a payment interface is provided to prompt a user to enter corresponding information.

In the embodiment of the present application, S201 may specifically include: The first client device displays a preset payment interface, where the payment interface at least includes a payer information entry item and a sum information entry item; the first client device acquires the payment order including the payer information and the sum information entered in the payment interface; and the first client device generates the payment request including the payment order, and sends the payment request to the server.

Of course, the payment order may also be acquired in other manners, for example, an existing payment order including payer information and an amount/sum confirmed between a buyer and a seller.

S202: The server verifies the payer information in the payment order.

The payer information includes a payment account number and a password thereof to ensure that a user that initiates payment currently is a valid user. The server may compare the account number and the password thereof with a registered account number and password to verify the identity of the user.

S203: After the verification succeeds, the server allocates a payment identifier to the payment order, and sends the payment identifier to the first client device.

After the identity of the user is verified, the payment order in the payment request is retrieved, and a current unique payment identifier is then allocated in the server, where the payment identifier is used to uniquely identify the payment order. 5202 and 5203 correspond to S102.

S204: The first client device encodes the payment identifier to generate an audio signal including the payment identifier, and broadcasts the audio signal including the payment identifier.

After receiving the payment identifier, the first client device encodes the payment identifier based on an audio coding rule set in an installed application to obtain an audio file carrying the payment identifier, that is, the audio signal including the payment identifier. After the audio signal including the payment identifier is obtained through encoding, prompt information may be sent to prompt the user to play the audio signal including the payment identifier to one or more payee users to initiate payment.

In the embodiment of the present application, S204 may specifically include: The first client device encodes the payment identifier to generate the audio signal including the payment identifier; the first client device displays a payment prompt interface, where the payment prompt interface is used to send a prompt that payment starts; and the first client device plays the generated audio signal including the payment identifier.

S205: A second client device decodes the monitored audio signal including the payment identifier to acquire the payment identifier, and sends a collection request including the payment identifier obtained through decoding and payee information to the server.

The second client device monitors and records the audio signal including the payment identifier played by the first client device with a built-in pickup device such as a microphone, and decodes the monitored audio signal including the payment identifier based on the corresponding audio coding rule to obtain the payment identifier in the audio signal including the payment identifier.

After obtaining the payment identifier, the second client device may also request to acquire the payee information, specifically, payee account number information of the payee user through a user interface, and generate a predefined collection request to send the collection request to the corresponding server, so that the server executes an existing process according to the embodiment of the present application. The second client device may specifically send the collection request to the server over a communications network, e.g., the Internet.

S206: After receiving the collection request, the server searches for the corresponding payment order according to the payment identifier, and initiates a payment transfer process according to the payment order and the payee information.

After receiving the collection request, the server may uniquely determine the payment order in S201 according to the payment identifier. After acquiring the payment order and the payee information, the server may initiate the payment transfer process according to the payer information and sum/amount in the payment order and the payee information. To put it simply, an account number corresponding to the payer information transfers, based on the sum/amount, a corresponding amount to a payee account number corresponding to the payee information. Specifically, the process of accomplishing payment based on the payment order and the payee information may be referred to the prior art, which is no longer elaborated here.

S207: The server detects whether the payment transfer process succeeds.

The server may specifically check whether transfer deduction is accomplished to determine whether the payment transfer process succeeds, and if transfer deduction is accomplished, determine that the current payment transfer process succeeds. Otherwise, the server may send a prompt that the payment fails to the first client device and the second client device.

S208: If the payment transfer process succeeds, send prompt information that the transaction succeeds to the first client device and the second client device.

The prompt information is used to prompt the first client device and the second client device that the current payment is successfully accomplished for the user, and if the payment transfer process fails, information such as a failure prompt and a failure prompt theme may further be sent.

It should be noted that the first client device and the second client device can implement communications between the server and the client through an instant communication account number or a user identifier such as a payment account number of the user.

S209: When receiving a payment end request carrying the payer information and/or the payment identifier sent by the first client device, the server deletes the payment order corresponding to the payer information and/or the payment identifier.

S209 may be executed at any time after S203, and the user can send a request to end current payment any time after S203.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user. After the payment succeeds, the payer and the payee user may further be notified in time. After the payment end request of the payer is received, the entire speech payment may be ended only by deleting the payment order corresponding to the payer information and/or the payment identifier, so as to avoid property loss of a user.

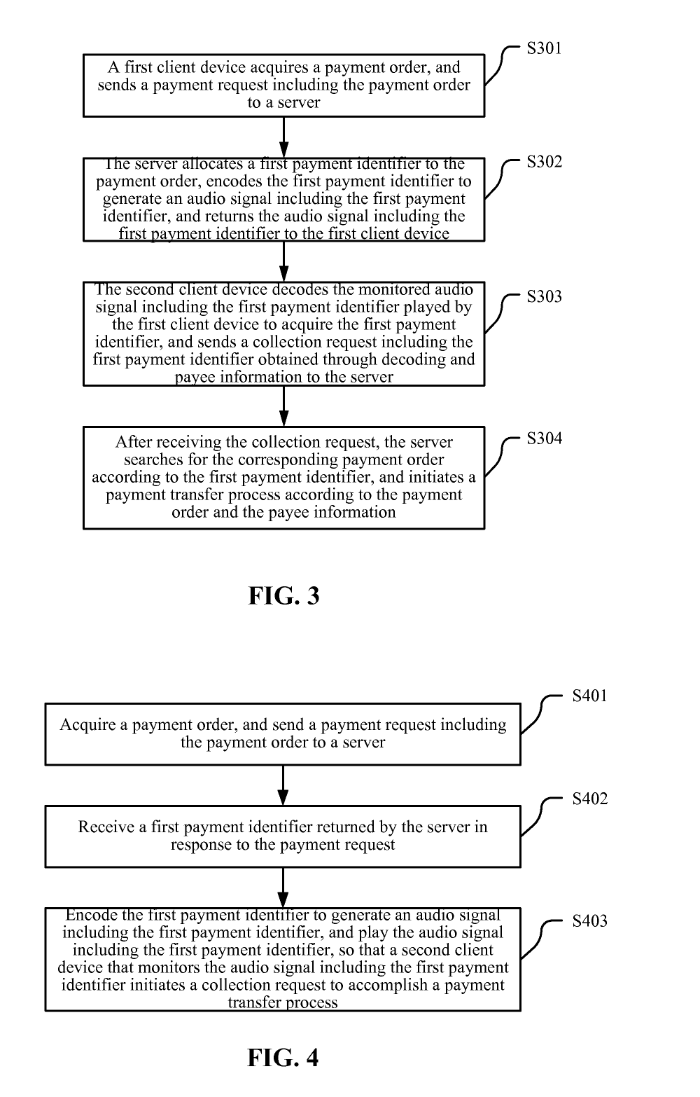

FIG. 3 is a schematic flow chart of a payment implementation method according to a third embodiment of the present application. The method according to the embodiment of the present application may be implemented in a terminal used for payment and a corresponding payment server. Specifically, the method includes:

S301: A first client device acquires a payment order, and sends a payment request including the payment order to a server.

The first client device may be, a mobile smart device, having a network function and set with a corresponding application, such as a smart mobile phone, a tablet computer, a personal computer, a wearable device, an electronic reader, a remote control, a vehicle-mounted device, of a payer.

The first client device acquires the payment order in several manners. Specifically, a payment interface is provided to prompt a user to enter corresponding information. In the embodiment of the present application, a user may only enter payer information of the payer and sum information about an amount to pay. The payer information is used to enable the server to confirm account information and payment password information of the user and verify the identity of the user, whereas the sum information is used to notify the server an amount of a single sum to pay at the current time.

Of course, the payment order may also be acquired in other manners, for example, an existing payment order including payer information and an amount/sum confirmed between a buyer and a seller.

The first client device generates, after acquiring the corresponding payment order, a payment request that is predefined with the server, so that the server executes relevant steps in the embodiment of the present application. The first client device may specifically send the generated payment request to the server over a communications network, e.g., the Internet.

S302: The server allocates a payment identifier to the payment order, encodes the payment identifier to generate an audio signal including the payment identifier, and returns the audio signal including the payment identifier to the first client device.

After receiving the payment request, the server retrieves the payment order in the payment request according to a data format of the payment request predefined with the terminal, and then allocates a current unique payment identifier in the server, where the payment identifier is used to uniquely identify the payment order.

After allocating the payment identifier, the server may encode the payment identifier based on an audio coding rule set in a relevant application to obtain an audio file carrying the payment identifier, that is, the audio signal including the payment identifier, and the server may also send the audio signal including the payment identifier to the first client device over a communications network, e.g., the Internet.

S303: A second client device decodes the monitored audio signal including the payment identifier played by the first client device to acquire the payment identifier, and sends a collection request including the payment identifier obtained through decoding and payee information to the server.

After the first client device receives the audio signal including the payment identifier generated by the server, when necessary, the user may choose the audio file and play the audio file with a terminal player. After the audio signal including the payment identifier is received, prompt information may be sent to prompt the user to play the audio signal including the payment identifier to one or more payee users to initiate payment.

The second client device may be, a mobile smart device, having a network function and set with a corresponding application, such as a smart mobile phone, a tablet computer, a personal computer, a wearable device, an electronic reader, a remote control, a vehicle-mounted device, of the payee user.

The second client device monitors and records the audio signal including the payment identifier played by the first client device with a built-in pickup device such as a microphone, and decodes the monitored audio signal including the payment identifier based on the corresponding audio coding rule to obtain the payment identifier in the audio signal including the payment identifier.

After obtaining the payment identifier, the second client device may also request to acquire the payee information, specifically, payee account number information of the payee user through a user interface, and generate a predefined collection request to send the collection request to the corresponding server, so that the server executes an existing process according to the embodiment of the present application. The second client device may specifically send the collection request to the server over a communications network, e.g., the Internet.

S304: After receiving the collection request, the server searches for the corresponding payment order according to the payment identifier, and initiates a payment transfer process according to the payment order and the payee information.

After receiving the collection request, the server may uniquely determine the payment order in S301 according to the payment identifier. After acquiring the payment order and the payee information, the server may initiate the payment transfer process according to the payer information and sum/amount in the payment order and the payee information. To put it simply, an account number corresponding to the payer information transfers, based on the sum/amount, a corresponding amount to a payee account number corresponding to the payee information. Specifically, the process of accomplishing payment based on the payment order and the payee information may be referred to the prior art, which is no longer elaborated here.

It should be noted that the first client device and the second client device can implement communications between the server and the client through an instant communication account number or a user identifier such as a payment account number of the user.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user.

FIG. 4 is a schematic flow chart of a payment implementation method according to a fourth embodiment of the present application. The method according to the embodiment of the present application is applicable to a mobile smart device, having a network function and set with a corresponding application, such as a smart mobile phone, a tablet computer, a personal computer, a wearable device, an electronic reader, a remote control, a vehicle-mounted device, that is, the above first client device. Specifically, the method includes:

S401: Acquire a payment order, and send a payment request including the payment order to a server.

The first client device acquires the payment order in several manners. Specifically, a payment interface is provided to prompt a user to enter corresponding information. In the embodiment of the present application, a user may only enter payer information of a payer and sum information about an amount to pay. The payer information is used to enable the server to confirm account information and payment password information of the user and verify the identity of the user, whereas the sum information is used to notify the server an amount of a single sum to pay at the current time.

Of course, the payment order may also be acquired in other manners, for example, an existing payment order including payer information and an amount/sum confirmed between a buyer and a seller.

The first client device generates, after acquiring the corresponding payment order, a payment request that is predefined with the server, so that the server executes relevant steps in the embodiment of the present application. The first client device may specifically send the generated payment request to the server over a communications network, e.g., the Internet.

S402: Receive a payment identifier returned by the server in response to the payment request, where the payment identifier is an identifier allocated by the server to the payment order in the payment request.

The manner in which the server returns the payment identifier in response to the payment request may be referred to the description of corresponding embodiments in FIG. 1 and FIG. 2.

S403: Encode the payment identifier to generate an audio signal including the payment identifier, and play the audio signal including the payment identifier, so that a second client device that monitors the audio signal including the payment identifier initiates a collection request to accomplish a payment transfer process.

After receiving the payment identifier, the first client device encodes the payment identifier based on an audio coding rule set in an installed application to obtain an audio file carrying the payment identifier, that is, the audio signal including the payment identifier, and when necessary, the user chooses the audio file and plays the audio file with a terminal player. After the audio signal including the payment identifier is obtained through encoding, prompt information may be sent to prompt the user to play the audio signal including the payment identifier to one or more payee users to initiate payment.

That the second client device initiates the collection request according to the payment identifier in the monitored audio signal including the payment identifier to accomplish the payment process may be referred to the description of corresponding embodiments in FIG. 1 and FIG. 2.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user.

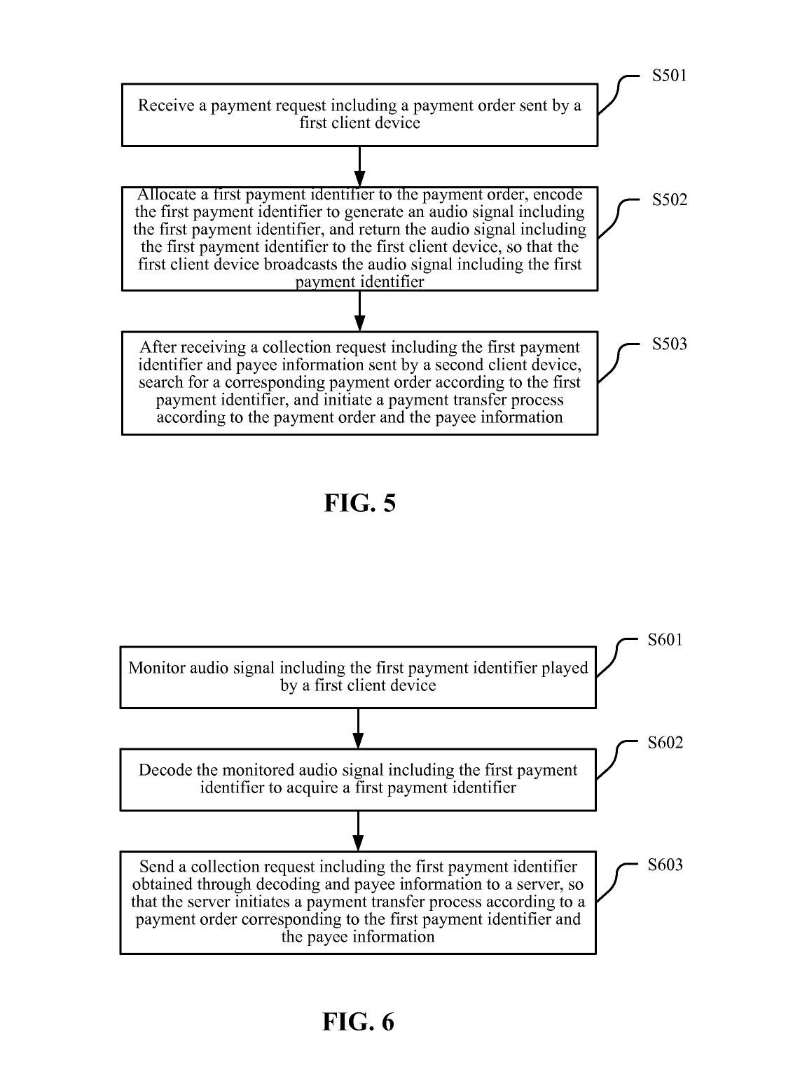

FIG. 5 is a schematic flow chart of a payment implementation method according to a fifth embodiment of the present application. The method in the embodiment of the present application may be implemented in a corresponding payment server, that is, the server in FIG. 3. Specifically, the method includes:

S501: Receive a payment request including a payment order sent by a first client device.

The process that the first client device acquires the payment order and sends the payment request may be referred to the description of corresponding embodiments in FIG. 1 to FIG. 3. A server may receive the payment request over the corresponding Internet or communications network.

S502: Allocate a payment identifier to the payment order, encode the payment identifier to generate an audio signal including the payment identifier, and return the audio signal including the payment identifier to the first client device, so that the first client device broadcasts the audio signal including the payment identifier.

After receiving the payment request, the server retrieves the payment order in the payment request according to a data format of the payment request predefined with a terminal, and then allocates a current unique payment identifier in the server, where the payment identifier is used to uniquely identify the payment order.

After allocating the payment identifier, the server may encode the payment identifier based on an audio coding rule set in a relevant application to obtain an audio file carrying the payment identifier, that is, the audio signal including the payment identifier, and the server may also send the audio signal including the payment identifier to the first client device over a communications network, e.g., the Internet.

S503: After a collection request including the payment identifier and payee information sent by a second client device is received, search for the corresponding payment order according to the payment identifier, and initiate a payment transfer process according to the payment order and the payee information.

The payment identifier in the collection request is acquired by the second client device from the monitored the audio signal including the payment identifier.

The process that the second client device sends the collection request including the payment identifier and the payee information may be referred to the description of corresponding embodiments in FIG. 1 to FIG. 3. After receiving the collection request, the server may uniquely determine the payment order in S501 according to the payment identifier. After acquiring the payment order and the payee information, the server may initiate the payment transfer process according to payer information and sum/amount in the payment order and the payee information. To put it simply, an account number corresponding to the payer information transfers, based on the sum/amount, a corresponding amount to a payee account number corresponding to the payee information. Specifically, the process of accomplishing payment based on the payment order and the payee information may be referred to the prior art, which is no longer elaborated here.

In addition, the method according to the embodiment of the present application may further include:

The server detects whether the payment transfer process succeeds. The server may specifically check whether transfer deduction is accomplished to determine whether the payment transfer process succeeds, and if transfer deduction is accomplished, determine that the current payment transfer process succeeds. If the payment transfer process succeeds, the server sends prompt information that the transaction succeeds to the first client device and the second client device.

At any time after the allocated payment identifier and the audio signal including the payment identifier time, the server may further delete, when receiving a payment end request carrying the payer information and/or the payment identifier sent by the first client device, the payment order corresponding to the payer information and/or the payment identifier and the audio signal including the payment identifier.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user.

FIG. 6 is a schematic flow chart of a payment implementation method according to a sixth embodiment of the present application. The method according to the embodiment of the present application is applicable to a mobile smart device, having a network function and set with a corresponding application, such as a smart mobile phone, a tablet computer, a personal computer, a wearable device, an electronic reader, a remote control, a vehicle-mounted device, that is, the above second client device. Specifically, the method includes:

S601: Monitor audio signal including the payment identifier played by a first client device.

The process that the first client device acquires and broadcasts the audio signal including the payment identifier may be referred to the description of corresponding embodiments in FIG. 1 to FIG. 3.

S602: Decode the monitored audio signal including the payment identifier to acquire a payment identifier.

A second client device monitors and records the audio signal including the payment identifier played by the first client device with a built-in pickup device such as a microphone, and decodes the monitored audio signal including the payment identifier based on a corresponding audio coding rule to obtain the payment identifier in the audio signal including the payment identifier.

S603: Send a collection request including the payment identifier obtained through decoding and payee information to a server, so that the server initiates a payment transfer process according to a payment order corresponding to the payment identifier and the payee information.

After obtaining the payment identifier, the second client device may also request to acquire the payee information, specifically, payee account number information of a payee user through a user interface, and generate a predefined collection request to send the collection request to the corresponding server, so that the server executes an existing process according to the embodiment of the present application. The second client device may specifically send the collection request to the server over a communications network, e.g., the Internet.

After receiving the collection request, the server may initiate the payment transfer process according to payer information and sum/amount in the payment order and the payee information. To put it simply, an account number corresponding to the payer information transfers, based on the sum/amount, a corresponding amount to a payee account number corresponding to the payee information. Specifically, the process of accomplishing payment based on the payment order and the payee information may be referred to the prior art, which is no longer elaborated here.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user.

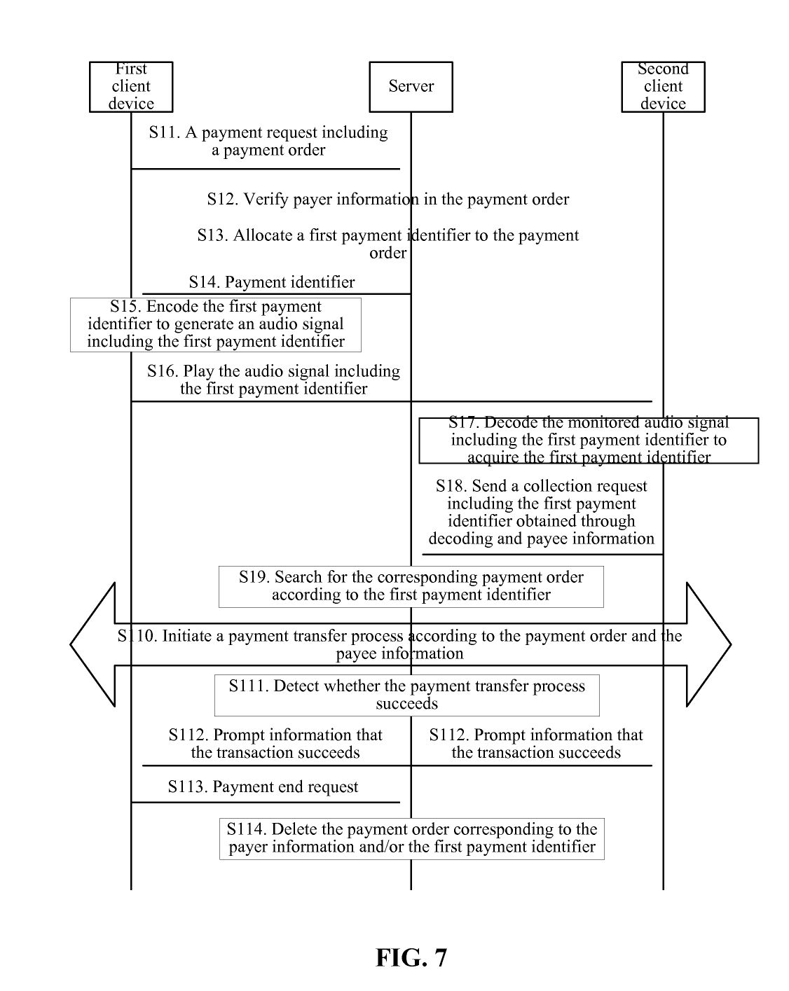

FIG. 7 is a schematic flow chart of a payment implementation method according to a seventh embodiment of the present application. The method according to the embodiment of the present application includes:

S11: A first client device sends a payment request including a payment order to a server. After acquiring the payment order, the first client device may send a payment end request to the server over a communications network, e.g., the Internet. The payment order includes payer information (e.g., a payment account) and sum information (e.g., a payment amount).

S12: The server verifies the payer information in the payment order, where the payer information includes an account number and password information, and verifies the payer information to ensure that a user that initiates payment currently is a valid user.

S13: After the verification succeeds, the server allocates a payment identifier to the payment order, where the payment identifier currently uniquely identifies the payment order from the first client device.

S14: The server sends the payment identifier to the first client device, and may also send the payment identifier over a communications network, e.g., the Internet.

S15: The first client device encodes the payment identifier to generate an audio signal including the payment identifier.

S16: The first client device broadcasts the audio signal including the payment identifier.

S17: A second client device decodes the monitored audio signal including the payment identifier to acquire the payment identifier.

S18: The second client device sends a collection request including the payment identifier obtained through decoding and payee information to the server.

S19: The server searches for the corresponding payment order according to the payment identifier.

S110: The server initiates a payment transfer process according to the payment order and the payee information.

S111: The server detects whether the payment transfer process succeeds.

S112: If the payment transfer process succeeds, the server sends prompt information that the transaction succeeds to the first client device and the second client device.

S113: The first client device sends a payment end request carrying the payer information and/or the payment identifier.

S114: The server deletes the payment order corresponding to the payer information and/or the payment identifier.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user. After the payment succeeds, the payer and a payee user may further be notified in time. After the payment end request of the payer is received, the entire speech payment may be ended only by deleting the payment order corresponding to the payer information and/or the payment identifier, so as to avoid property loss of a user.

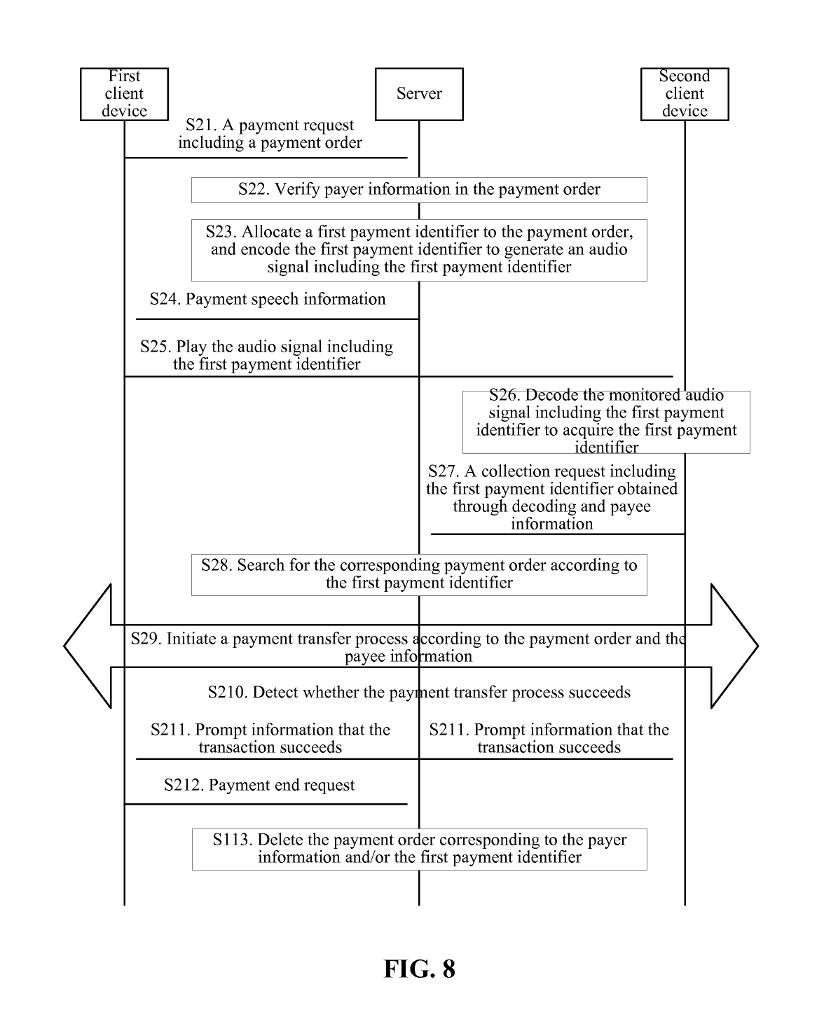

FIG. 8 is a schematic flow chart of a payment implementation method according to an eighth embodiment of the present application. The method according to the embodiment of the present application includes:

S21: A first client device sends a payment request including a payment order to a server. After acquiring the payment order, the first client device may send a payment end request to the server over a communications network, e.g., the Internet. The payment order includes payer information (e.g., a payment account) and sum information (e.g., a payment amount).

S22: The server verifies the payer information in the payment order, where the payer information includes an account number and password information, and verifies the payer information to ensure that a user that initiates payment currently is a valid user.

S23: After the verification succeeds, the server allocates a payment identifier to the payment order, and encodes the payment identifier to generate an audio signal including the payment identifier, where the payment identifier currently uniquely identifies the payment order from the first client device.

S24: The server sends the audio signal including the payment identifier to the first client device, and may also send the payment identifier over a communications network, e.g., the Internet.

S25: The first client device broadcasts the audio signal including the payment identifier.

S26: A second client device decodes the monitored audio signal including the payment identifier to acquire the payment identifier.

S27: The second client device sends a collection request including the payment identifier obtained through decoding and payee information to the server.

S28: The server searches for the corresponding payment order according to the payment identifier.

S29: The server initiates a payment transfer process according to the payment order and the payee information.

S210: The server detects whether the payment transfer process succeeds.

S211: If the payment transfer process succeeds, the server sends prompt information that the transaction succeeds to the first client device and the second client device.

S212: The first client device sends the payment end request carrying the payer information and/or the payment identifier.

S213: The server deletes the payment order corresponding to the payer information and/or the payment identifier and the audio signal including the payment identifier.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user. After the payment succeeds, the payer and a payee user may further be notified in time. After the payment end request of the payer is received, the entire speech payment may be ended only by deleting the payment order corresponding to the payer information and/or the payment identifier, so as to avoid property loss of a user.

The payment implementation apparatus and system according to the embodiments of the present application are described in detail below.

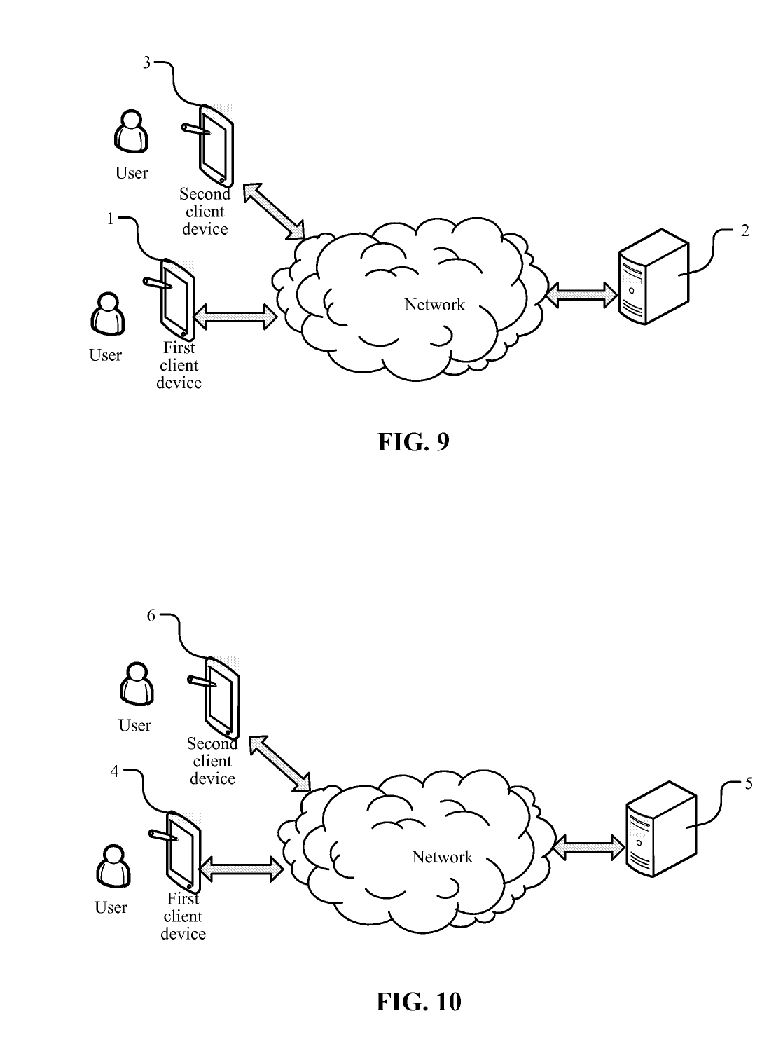

FIG. 9 is a schematic structural view of a payment implementation system according to an embodiment of the present application. The system according to the embodiment of the present application includes: a first client device 1, a server 2, and at least one second client device 3, where the first client device 1 and the at least one second client device 3 may be a mobile smart device, having a network function and set with a corresponding application, such as a smart mobile phone, a tablet computer, a personal computer, a wearable device, an electronic reader, a remote control, a vehicle-mounted device, of a payer. The server 2 may be a payment server 2, and communications between the first client device 1 and the at least one second client device 3, communications between the first client device 1 and the server 2, and communications between the at least one second client device 3 and the server 2 may be implemented through an instant communication account number or a user identifier such as a payment account number of a user.

The first client device 1 is used to acquire a payment order, and sends a payment request including the payment order to the server 2.

The server 2 is used to allocate a payment identifier to the payment order and send the payment identifier to the first client device 1.

The first client device 1 is further used to encode the payment identifier to generate an audio signal including the payment identifier and play the audio signal including the payment identifier.

The at least one second client device 3 is used to decode the monitored audio signal including the payment identifier to acquire the payment identifier and send a collection request including the payment identifier obtained through decoding and payee information to the server 2.

The server 2 is further used to search for, after receiving the collection request, the corresponding payment order according to the payment identifier, and initiate a payment transfer process according to the payment order and the payee information.

In the system according to the embodiment of the present application, the specific implementation of the first client device 1, the at least one second client device 3, and the server 2 may be referred to the description of the corresponding embodiments in FIG. 1 and FIG. 2, which is no longer elaborated here.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user.

FIG. 10 is a schematic structural view of another payment implementation system according to an embodiment of the present application. The system according to the embodiment of the present application includes: a first client device 4, a server 5, and at least one second client device 6. The first client device 4 and the at least one second client device 6 may be a mobile smart device, having a network function and set with a corresponding application, such as a smart mobile phone, a tablet computer, a personal computer, a wearable device, an electronic reader, a remote control, a vehicle-mounted device, of a payer. The server 5 may be a payment server 5, and communications between the first client device 4 and the at least one second client device 6, communications between the first client device 4 and the server 5, and communications between the at least one second client device 6 and the server 5 may be implemented through an instant communication account number or a user identifier such as a payment account number of a user.

The first client device 4 is used to acquire a payment order, and send a payment request including the payment order to the server 5.

The server 5 is used to allocate a payment identifier to the payment order, encode the payment identifier to generate an audio signal including the payment identifier, and return the audio signal including the payment identifier to the first client device 4.

The at least one second client device 6 is used to decode the monitored audio signal including the payment identifier played by the first client device 4 to acquire the payment identifier and send a collection request including the payment identifier obtained through decoding and payee information to the server 5.

The server 5 is further used to search for, after receiving the collection request, the corresponding payment order according to the payment identifier, and initiate a payment transfer process according to the payment order and the payee information.

In the system according to the embodiment of the present application, the specific implementation of the first client device 4, the at least one second client device 6, and the server 5 may be referred to the description of the corresponding embodiment in FIG. 3, which is no longer elaborated here.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user.

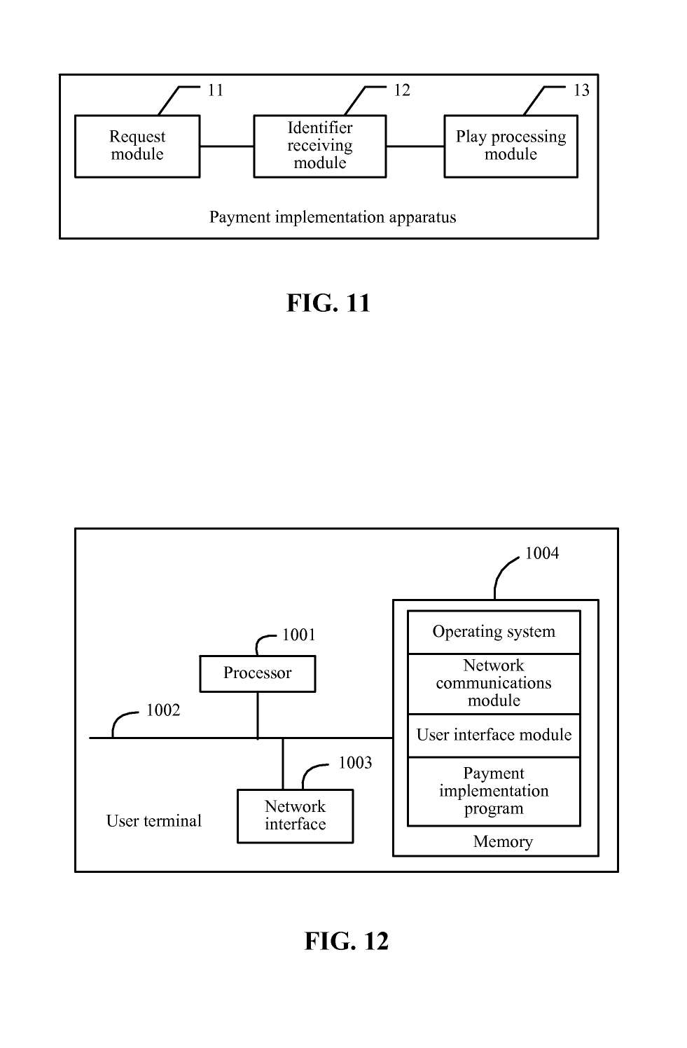

FIG. 11 is a schematic structural view of a payment implementation apparatus according to an embodiment of the present application. The apparatus according to the embodiment of the present application may be set in a mobile smart device, having a network function and installed with a corresponding application, such as a smart mobile phone, a tablet computer, a personal computer, a wearable device, an electronic reader, a remote control, and a vehicle-mounted device. Specifically, the apparatus includes:

a request module 11, used to acquire a payment order, and send a payment request including the payment order to a server;

an identifier receiving module 12, used to receive a payment identifier returned by the server in response to the payment request, where the payment identifier is an identifier allocated by the server to the payment order in the payment request; and

a play processing module 13, used to encode the payment identifier to generate an audio signal including the payment identifier and play the audio signal including the payment identifier, so that a second client device that monitors the audio signal including the payment identifier initiates a collection request to accomplish a payment transfer process.

The specific implementation of the request module 11, the identifier receiving module 12, and the play processing module 13 of the apparatus according to the embodiment of the present application may be referred to the relevant description of corresponding embodiments in FIG. 1 and FIG. 2. Furthermore, in the embodiment of the present application, the request module 11 is specifically used to display a preset payment interface, where the payment interface at least includes a payer information entry item and a sum information entry item; acquire the payment order including payer information and sum information entered in the payment interface; and generate the payment request including the payment order and send the payment request to the server.

Also, the request module 11 may be further used to send a payment end request carrying the payer information and/or the payment identifier to the server, so that the server deletes the payment order corresponding to the payer information and/or the payment identifier according to the payment end request.

Further preferably, the play processing module 13 is specifically used to encode the payment identifier to generate the audio signal including the payment identifier; display the payment prompt interface, where the payment prompt interface is used to send a prompt that payment starts; and play the generated audio signal including the payment identifier.

FIG. 12 is a schematic structural view of a user terminal according to an embodiment of the present application. The user terminal according to the embodiment of the present application includes: at least one processor 1001, for example, a CPU, at least one communication bus 1002, at least one network interface 1003, and a memory 1004. The communication bus 1002 is used to implement connection and communications among these components. The network interface 1003 may optionally include a standard wired interface and wireless interface (such as WI-FI and a mobile communications interface). The memory 1004 may be a high-speed RAM memory, or may also be a non-transitory computer readable storage medium, e.g., non-volatile memory or one disk memory. The memory 1004 optionally may further be at least one storage apparatus located far away from the processor 1001. As shown in FIG. 12, in the memory 1004 that serves as a computer storage medium, an operating system and a network communications module are stored, and a payment processing program and other programs are stored.

Specifically, the processor 1001 may be used to invoke the payment processing program stored in the memory 1004 to execute the following steps:

acquiring a payment order, and sending a payment request including the payment order to a server;

receiving a payment identifier returned by the server in response to the payment request, where the payment identifier is an identifier allocated by the server to the payment order in the payment request; and

encoding the payment identifier to generate an audio signal including the payment identifier and playing the audio signal including the payment identifier, so that a second client device that monitors the audio signal including the payment identifier initiates a collection request to accomplish a payment transfer process.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user.

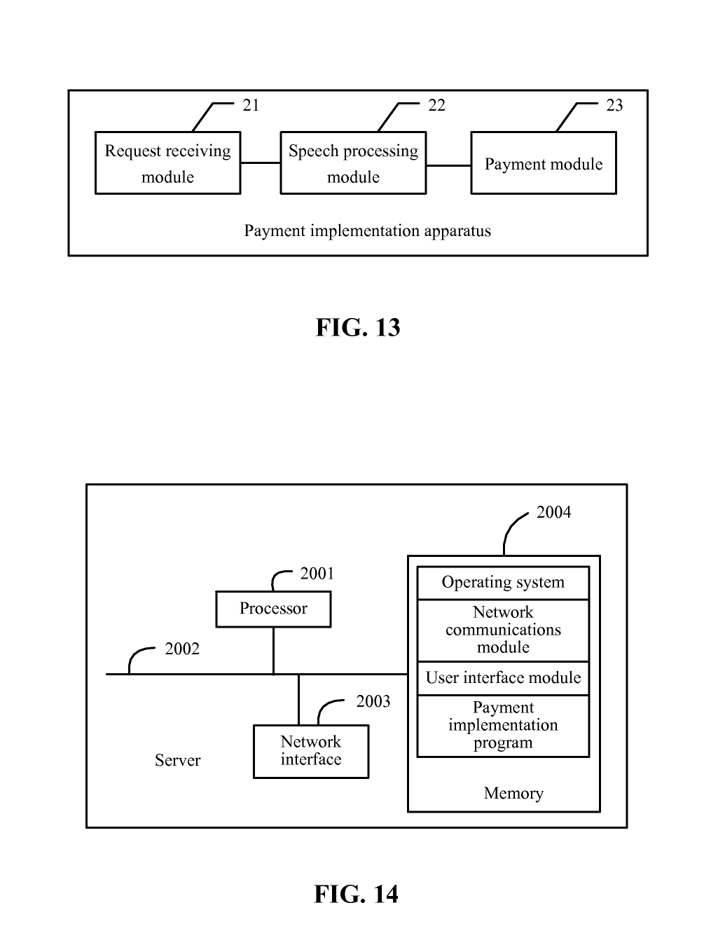

Furthermore, FIG. 13 is a schematic structural view of another payment implementation apparatus according to an embodiment of the present application. The apparatus according to the embodiment of the present application may be set in a relevant payment server. Specifically, the apparatus includes:

a request receiving module 21, used to receive a payment request including a payment order sent by a first client device;

a speech processing module 22, used to allocate a payment identifier to the payment order, encode the payment identifier to generate an audio signal including the payment identifier, and return the audio signal including the payment identifier to the first client device, so that the first client device broadcasts the audio signal including the payment identifier; and

a payment module 23, used to search for, after a collection request including the payment identifier and payee information sent by a second client device is received, the corresponding payment order according to the payment identifier, and initiate a payment transfer process according to the payment order and the payee information.

The payment identifier in the collection request is acquired by the second client device from the monitored the audio signal including the payment identifier.

The specific implementation of the request receiving module 21, the speech processing module 22, and the payment module 23 of the apparatus according to the embodiment of the present application may be referred to the relevant description of the embodiment in FIG. 3. Also, in the embodiment of the present application, the speech processing module 22 is specifically used to verify payer information in the payment order; after the verification succeeds, allocate the payment identifier to the payment order, encode the payment identifier to generate the audio signal including the payment identifier, and return the audio signal including the payment identifier to the first client device, so that the first client device broadcasts the audio signal including the payment identifier.

Further preferably, the apparatus according to the embodiment of the present application may further include a deletion module. The deletion module is used to delete, when a payment end request carrying the payer information and/or the payment identifier sent by the first client device is received, the payment order corresponding to the payer information and/or the payment identifier.

Further preferably, the apparatus according to the embodiment of the present application may further include a prompt module. The prompt module is used to detect whether the payment transfer process succeeds; and if the payment transfer process succeeds, send prompt information that the transaction succeeds to the first client device and the second client device.

FIG. 14 is a schematic structural view of a server according to an embodiment of the present application. The server according to the embodiment of the present application includes: at least one processor 2001, for example, a CPU, at least one communication bus 2002, at least one network interface 2003, and a memory 2004. The communication bus 2002 is used to implement connection and communications among these components. The network interface 2003 may optionally include a standard wired interface and wireless interface (such as WI-FI and a mobile communications interface). The memory 2004 may be a high-speed RAM memory, or may also be a non-transitory computer readable storage medium, e.g., non-volatile memory or one disk memory. The memory 2004 optionally may further be at least one storage apparatus located far away from the processor 2001. As shown in FIG. 14, in the memory 2004 that serves as a computer storage medium, an operating system and a network communications module are stored, and a payment processing program and other programs are stored. A more detailed description of the payment processing program is provided above in connection with FIGS. 1-8.

Specifically, the processor 2001 may be used to invoke the payment processing program stored in the memory 2004 to execute the following steps: receiving a payment request including a payment order sent by a first client device; allocating a payment identifier to the payment order, encoding the payment identifier to generate an audio signal including the payment identifier, and returning the audio signal including the payment identifier to the first client device, so that the first client device broadcasts the audio signal including the payment identifier; and searching for, after a collection request including the payment identifier and payee information sent by a second client device is received, the corresponding payment order according to the payment identifier, and initiating a payment transfer process according to the payment order and the payee information.

The payment identifier in the collection request is acquired by the second client device from the monitored the audio signal including the payment identifier.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user.

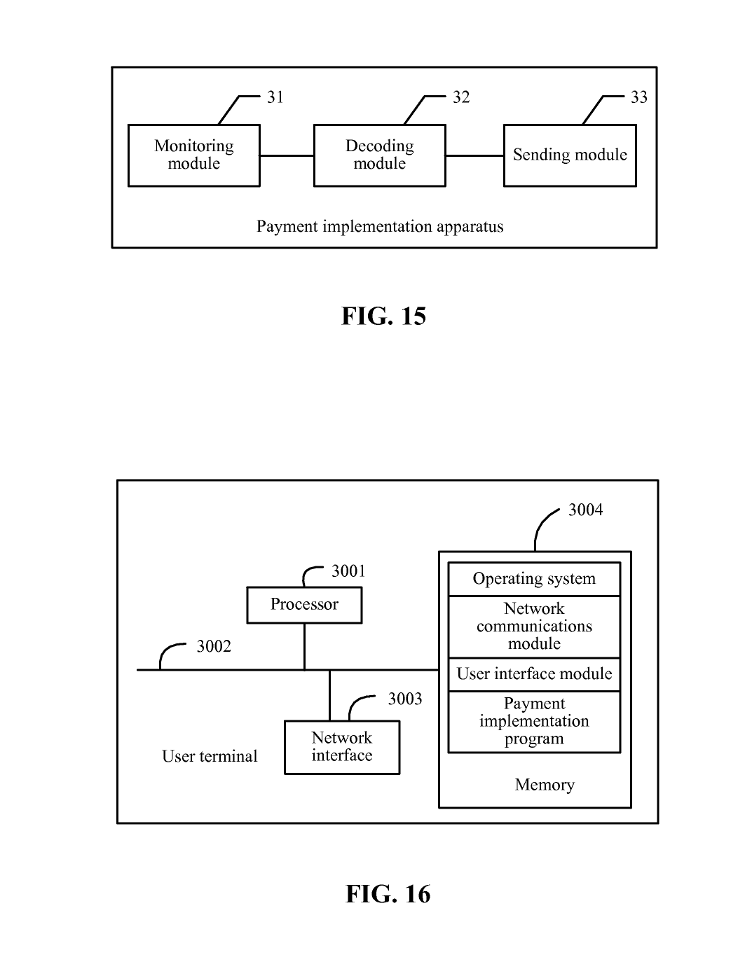

Furthermore, referring to FIG. 15, FIG. 15 is a schematic structural view of yet another payment implementation apparatus according to an embodiment of the present application. The apparatus according to the embodiment of the present application may be set in a mobile smart device, having a network function and installed with a corresponding application, such as a smart mobile phone, a tablet computer, a personal computer, a wearable device, an electronic reader, a remote control, and a vehicle-mounted device. Specifically, the apparatus includes: a monitoring module 31, used to monitor audio signal including the payment identifier played by a first client device; a decoding module 32, used to decode the monitored audio signal including the payment identifier to acquire a payment identifier; and a sending module 33, used to send a collection request including the payment identifier obtained through decoding and payee information to a server, so that the server initiates a payment transfer process according to a payment order corresponding to the payment identifier and the payee information.

The specific implementation of the monitoring module 31, the decoding module 32, and the sending module 33 of the apparatus according to the embodiment of the present application may be referred to the description of corresponding embodiments in FIG. 1 to FIG. 3.

FIG. 16 is a schematic structural view of a user terminal according to an embodiment of the present application. The user terminal according to the embodiment of the present application includes: at least one processor 3001, for example, a CPU, at least one communication bus 3002, at least one network interface 3003, and a memory 3004. The communication bus 3002 is used to implement connection and communications among these components. The network interface 3003 may optionally include a standard wired interface and wireless interface (such as WI-FI and a mobile communications interface). The memory 3004 may be a high-speed RAM memory, or may also be a non-transitory computer readable storage medium, e.g., non-volatile memory or one disk memory. The memory 3004 optionally may further be at least one storage apparatus located far away from the processor 3001. As shown in FIG. 16, in the memory 3004 that serves as a computer storage medium, an operating system and a network communications module are stored, and a payment processing program and other programs are stored.

Specifically, the processor 3001 may be used to invoke the payment processing program stored in the memory 3004 to execute following steps: monitoring audio signal including the payment identifier played by a first client device; decoding the monitored audio signal including the payment identifier to acquire a payment identifier; and sending a collection request including the payment identifier obtained through decoding and payee information to a server, so that the server initiates a payment transfer process according to a payment order corresponding to the payment identifier and the payee information.

In the embodiment of the present application, a unique payment identifier may be allocated to a payment order of a user, and audio encoding is then performed on the payment identifier to obtain audio signal including the payment identifier. A payer may play the audio signal including the payment identifier as a response to one or more other users according to needs, and other users may request a server to accomplish payment according to the payment identifier in the audio signal including the payment identifier. The payer does not need to initiate a payment process for each receiver one by one, thereby conveniently and rapidly implement one-to-one or one-to-multiple payment; especially, for a scenario of payment of a small but equal amount such as “red envelope” delivery, it becomes very convenient for a user, time is saved, and errors do not occur easily, thereby meeting the demands for automation and intelligence of the user.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

What is claimed is:

1. A method for performing a payment transaction, the method comprising:
at a computer server having one or more processors and memory storing program modules to be executed by the one or more processors:
providing a first mobile payment application to be installed in a first mobile client device and a second mobile payment application to be installed in a second mobile client device, respectively;
receiving a payment request including a payment order sent by the first mobile client device using the first mobile payment application via a first wireless communication channel;
in response to receiving the payment request:
allocating a first payment identifier to the payment order;
establishing a second wireless communication channel with the first mobile client device;
returning a response including the first payment identifier to the first mobile client device via the second wireless communication channel, wherein the first mobile client device is configured to generate an audio signal associated with the response and broadcast the audio signal including information of the first payment identifier using the first mobile payment application;
receiving a collection request including a second payment identifier and payee information from the second mobile client device using the second mobile payment application via a third wireless communication channel, wherein the second mobile client device is configured to generate the collection request using the second mobile payment application in response to a detection of the audio signal broadcasted by the first mobile client device; and
in accordance with a determination that the second payment identifier corresponds to the first payment identifier, processing the payment order using the payee information and sending a payment completion message to the first mobile client device.

2. The method of claim 1, wherein the payment order includes a payment account and a payment amount, the method further comprising:
determining whether the payment account has sufficient fund for the payment amount; and
in accordance with a determination that the payment account has sufficient fund, generating the first payment identifier in accordance with the payment account and the payment amount; and
in accordance with a determination that the payment account has insufficient fund, generating a message indicating that the payment account has insufficient fund and returning the message to the first mobile client device.

3. The method of claim 1, wherein the response includes the audio signal and the first payment identifier is encoded into the audio signal at the server.

4. The method of claim 1, wherein the response includes the first payment identifier and the first payment identifier is encoded into the audio signal at the first mobile client device.

5. The method of claim 1, wherein the second payment identifier is the same as the first payment identifier.

6. The method of claim 1, wherein the second payment identifier is different from the first payment identifier.

7. The method of claim 1, further comprising:
determining a time difference between the payment request and the collection request; and
in accordance with a determination that the time difference is less than or equal to a predefined time threshold value, processing the payment order; and
in accordance with a determination that the time difference is greater than the predefined time threshold value:
generating a payment alert message and sending the payment alert message to the first mobile client device via the second wireless communication channel; and
processing the payment order after receiving a payment confirmation message from the first mobile client device via the second wireless communication channel.

8. The method of claim 1, further comprising:
determining a location difference between the payment request and the collection request; and
in accordance with a determination that the location difference is less than or equal to a predefined location threshold value, processing the payment order; and
in accordance with a determination that the location difference is greater than the predefined location threshold value:
generating a payment alert message and sending the payment alert message to the first mobile client device via the second wireless communication channel; and
processing the payment order after receiving a payment confirmation message from the first mobile client device via the second wireless communication channel.

9. A computer server comprising:
one or more processors;
memory; and
one or more program modules stored in the memory and to be executed by the one or more processors, the program modules further including instructions for:
providing a first mobile payment application to be installed in a first mobile client device and a second mobile payment application to be installed in a second mobile client device, respectively;
receiving a payment request including a payment order sent by the first mobile client device using the first mobile payment application via a first wireless communication channel;
in response to receiving the payment request:
allocating a first payment identifier to the payment order;
establishing a second wireless communication channel with the first mobile client device;
returning a response including the first payment identifier to the first mobile client device via the second wireless communication channel, wherein the first mobile client device is configured to generate an audio signal associated with the response and broadcast the audio signal including information of the first payment identifier using the first mobile payment application;
receiving a collection request including a second payment identifier and payee information from the second mobile client device using the second mobile payment application via a third wireless communication channel, wherein the second mobile client device is configured to generate the collection request using the second mobile payment application in response to a detection of the audio signal broadcasted by the first mobile client device; and
in accordance with a determination that the second payment identifier corresponds to the first payment identifier, processing the payment order using the payee information and sending a payment completion message to the first mobile client device.

10. The computer server of claim 9, wherein the payment order includes a payment account and a payment amount, and the one or more program modules further include instructions for:
determining whether the payment account has sufficient fund for the payment amount; and
in accordance with a determination that the payment account has sufficient fund, generating the first payment identifier in accordance with the payment account and the payment amount; and
in accordance with a determination that the payment account has insufficient fund, generating a message indicating that the payment account has insufficient fund and returning the message to the first mobile client device.

11. The computer server of claim 9, wherein the response includes the audio signal and the first payment identifier is encoded into the audio signal at the server.

12. The computer server of claim 9, wherein the response includes the first payment identifier and the first payment identifier is encoded into the audio signal at the first mobile client device.

13. The computer server of claim 9, wherein the second payment identifier is the same as the first payment identifier.

14. The computer server of claim 9, wherein the second payment identifier is different from the first payment identifier.

15. The computer server of claim 9, wherein the one or more program modules further include instructions for:
determining a time difference between the payment request and the collection request; and
in accordance with a determination that the time difference is less than or equal to a predefined time threshold value, processing the payment order; and
in accordance with a determination that the time difference is greater than the predefined time threshold value:
generating a payment alert message and sending the payment alert message to the first mobile client device via the second wireless communication channel; and
processing the payment order after receiving a payment confirmation message from the first mobile client device via the second wireless communication channel.

16. The computer server of claim 9, wherein the one or more program modules further include instructions for:
determining a location difference between the payment request and the collection request; and
in accordance with a determination that the location difference is less than or equal to a predefined location threshold value, processing the payment order; and
in accordance with a determination that the location difference is greater than the predefined location threshold value:
generating a payment alert message and sending the payment alert message to the first mobile client device via the second wireless communication channel; and
processing the payment order after receiving a payment confirmation message from the first mobile client device via the second wireless communication channel.

17. A non-transitory computer readable storage medium storing one or more program modules in connection with a computer server having one or more processors, the one or more program modules comprising instructions, which, when executed by the one or more processors, cause the computer server to perform operations comprising:
providing a first mobile payment application to be installed in a first mobile client device and a second mobile payment application to be installed in a second mobile client device, respectively;
receiving a payment request including a payment order sent by the first mobile client device using the first mobile payment application via a first wireless communication channel;
in response to receiving the payment request:
allocating a first payment identifier to the payment order;
establishing a second wireless communication channel with the first mobile client device;
returning a response including the first payment identifier to the first mobile client device via the second wireless communication channel, wherein the first mobile client device is configured to generate an audio signal associated with the response and broadcast the audio signal including information of the first payment identifier using the first mobile payment application;
receiving a collection request including a second payment identifier and payee information from the second mobile client device using the second mobile payment application via a third wireless communication channel, wherein the second mobile client device is configured to generate the collection request using the second mobile payment application in response to a detection of the audio signal broadcasted by the first mobile client device; and
in accordance with a determination that the second payment identifier corresponds to the first payment identifier, processing the payment order using the payee information and sending a payment completion message to the first mobile client device.

18. The non-transitory computer readable storage medium of claim 17, wherein the payment order includes a payment account and a payment amount, and the one or more program modules further include instructions for:
determining whether the payment account has sufficient fund for the payment amount; and
in accordance with a determination that the payment account has sufficient fund, generating the first payment identifier in accordance with the payment account and the payment amount; and
in accordance with a determination that the payment account has insufficient fund, generating a message indicating that the payment account has insufficient fund and returning the message to the first client device.

19. The non-transitory computer readable storage medium of claim 17, wherein the one or more program modules further include instructions for:
determining a time difference between the payment request and the collection request; and
in accordance with a determination that the time difference is less than or equal to a predefined time threshold value, processing the payment order; and
in accordance with a determination that the time difference is greater than the predefined time threshold value:
generating a payment alert message and sending the payment alert message to the first mobile client device via the second wireless communication channel; and
processing the payment order after receiving a payment confirmation message from the first mobile client device via the second wireless communication channel.

20. The non-transitory computer readable storage medium of claim 17, wherein the one or more program modules further include instructions for:
determining a location difference between the payment request and the collection request; and
in accordance with a determination that the location difference is less than or equal to a predefined location threshold value, processing the payment order; and
in accordance with a determination that the location difference is greater than the predefined location threshold value:
generating a payment alert message and sending the payment alert message to the first mobile client device via the second wireless communication channel; and
processing the payment order after receiving a payment confirmation message from the first mobile client device via the second wireless communication channel.
